(19) United States
(12) Patent Application Publication
(10) Pub. No.: US 2006/0060670 A1
(43) Pub. Date: Mar. 23, 2006

(54) Spray device

(76) Inventor: Brian Hartley, CHESHIRE (GB)

Correspondence Address: SMITH-HILL AND BEDELL, P.C., 16100 NW CORNELL ROAD, SUITE 220, BEAVERTON, OR, 97006, US

(21) Appl. No.: 10/531,643

(22) PCT Filed: Oct. 9, 2003
(86) PCT No.: PCT/GB03/04370

§ 371 Date: May 4, 2005

(30) Foreign Application Priority Data
Oct. 16, 2002 (GB) 0224052.1
Feb. 19, 2003 (GB) 0303726.4

(51) Int. Cl. B05B 9/00

(52) U.S. Cl. 239/319

(57) ABSTRACT

A spray device is provided in which a spray stem section is secured within a passage of a spray device body. The stem section is readily removable to allow easy cleaning and also is normally made of materials which allow disposal after use of the stem section. In order to allow such use of plastics materials, in particular the stem section is associated with the passage such that seal elements isolate feed ports over a relatively broad communication band to gutter channels in the stem section. Normally a nozzle combination is secured within a jet such that this combination is also separately disposable. The nozzle combination is held within the spray stem section using a spray hood.

The present invention relates to spray devices and more particularly to such spray devices utilised for. dispersing liquids such as paint or wood preservatives upon surfaces and structures.

Traditionally there are three general approaches to applying liquid such as paints or preservatives to surfaces or structures. These approaches utilise brushes or rollers or a spray device in the form of a gun. The present invention in particular relates to paint spray devices which have a number of advantages including more economical fluid distribution on the sprayed surface without brush or roller marks. However, paint spraying devices have a number of problems which have tended to limit their widespread use in particular by amateur or domestic users.

One problem associated with paint spray devices is the frequent need to clean them after use and also that they can require frequent topping up with paint. They can also put a strain on the user's hand particularly when a paint canister is full and attached to the spray gun head.

By their nature, spraying devices require accurate association between various components in order to achieve an appropriate spray distribution. Such accurate association and reliability have necessitated use of metal components to ensure a sufficient robustness for industrial use. These requirements for reliable and robust association for acceptability within the heavy usage environments of commercial and industrial applications have further exacerbated the acceptability of paint spray devices by amateur and domestic users. It will be understood that amateur and domestic users will generally have much smaller surface areas which require spray application and only require infrequent use.

In accordance with the present invention there is provided a spray device comprising projection means to generate a fluid spray projection through a passage, a spray stem axially aligned within the passage to allow removal through an end of the passage, the stem including isolation means such that, when aligned, respective feed ports in the passage are isolated from one another and thereby fluid for the fluid spray projection may pass through at least one such feed port into the spray stem for spray projection out of a nozzle of the stem.

Typically, the isolation means comprises O ring seals about the stem. Typically, the O ring seals are secured within grooves formed in the stem. Generally, spacing between the isolation means defines an acceptable tolerance band width for association with respective feed ports of the device.

Typically, the feed ports communicate with circumferential channels formed in the stem. Normally, these circumferential channels include sink apertures connected to a jet. Normally the jet directly leads to the nozzle and incorporates at least part of the means to generate a fluid spray projection.

Typically, the projection means includes a piston. Normally, this piston is electrically vibrated in order to stimulate spray projection. Generally, the piston is also axially removable from the spray stem either with the spray stem from the passage or independently.

Generally, the spray stem and the passage are a close fit. Possibly, the spray stem and passage have reciprocal tapered or conical shaping.

Typically, the spray stem is secured to the passage at the end of the passage. Normally the stem is secured to the passage through a screw thread engagement or bayonet fitting or using a retaining screw.

Normally the spray stem is made from a plastics material.

A separable spray stem containing the jet and spray projection mechanism means that the complete assembly can be made cheap enough to be discarded, or a separate part could be provided to allow one to be soaking in cleaning fluid whilst the other is being used.

There are at present spraying devices which are hand held and attached by a tube to a separate canister. There are also spray guns with canisters attached. These devices can be expensive.

It would be advantageous to provide a method whereby the operator of such products can have a cheap alternative and the versatility provided by a device which is also easy to clean, and may also have throw-away parts as an alternative to cleaning should the operator decide to discard them.

The main driving force of the spray device is provided by an electrically operated vibrator which can use the mains electrical supply or a battery.

The section containing the vibrator can have a handle fitted to the main body of the gun or it may be fitted on the fluid canister. This allows it to be fitted to the top of a tin containing a suitably diluted liquid which will pass easily through a spray jet head, for example fence protective liquid. This reduces the necessity to keep frequently filling a separate container which is usually attached to such spray guns. It also reduces the need to have to clean containers after use.

To enable the vibrator mechanism to be fitted to the top of a tin containing paint, a hole has to be made in the lid; this is done by the use of a specially shaped spike which can be hammered or pushed into it. The bottom of the vibrator mechanism has a threaded section which is placed through the hole and a collar is then screwed onto this when the lid has been removed. A rubber washer is used between the threaded section and the collar to stop any leakage of paint and air. The section which is threaded has a piece shaped in the centre to allow a tube with filter on the bottom to be pushed into it. Several tubes varying in length with detachable filters can be provided to reach to the bottom of tins that vary in depth, or a flexible tube could be used.

An adapter to replace the jet spray assembly, which is fitted on the spray gun to allow a small bore tube to be fitted to it, and a handle equipped with a jet attached to the other end. The tube and handle can be made cheap enough to throw away after use, and even the section containing the piston and jet assembly can be made cheap enough to throwaway to alleviate the need for cleaning.

Should the need arise for a small quantity of paint to be used, this can still be used in a separate container which has a handle attached to it, on the main body of the spray gun. To operate the vibrator when it is connected to the mains or battery voltage supply, a switch is suitably positioned on the side of the body containing it if the handle is on the jar. The switch is situated so that it can be suitably operated because the separate container's handle lines up with it. This is possible because the section housing the vibrator mechanism has a section either side of it that protrudes and has holes through them. These line up with sections that protrude on the separate container; two screws are used to secure them together and a rubber seal is fitted between to stop any liquid which may be in the container from leaking out.

Embodiments of the present invention will now be described by way of example only, with reference to the accompanying drawings in which:

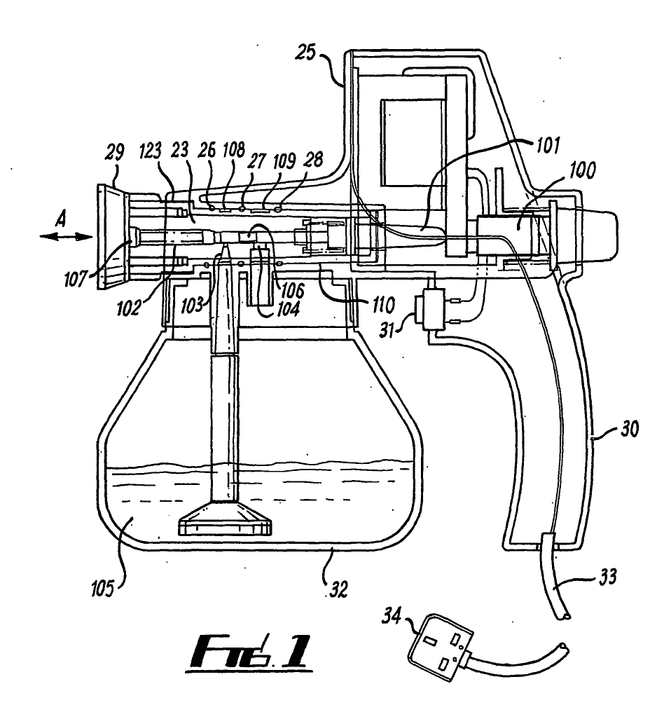

FIG. 1 is a side cross section of a spray device in accordance with the present invention;

FIG. 2 is a cross section of a spray stem with nozzle;

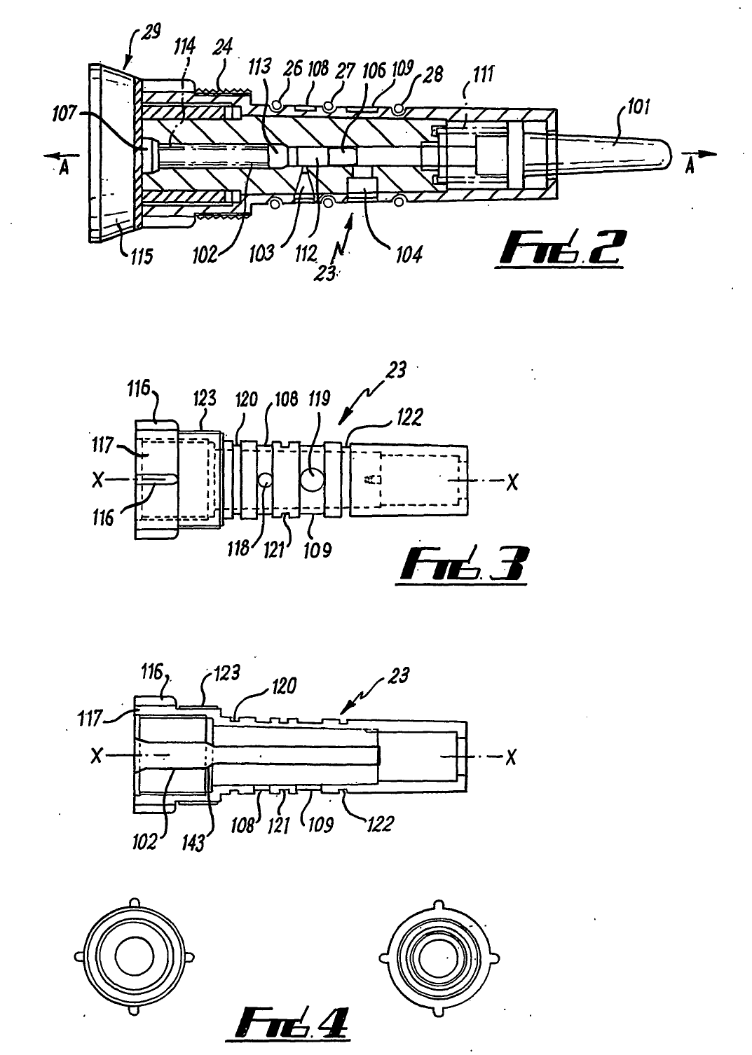

FIG. 3 is a side view of a spray stem component;

FIG. 4 is a side cross section of the spray stem illustrated in FIG. 3;

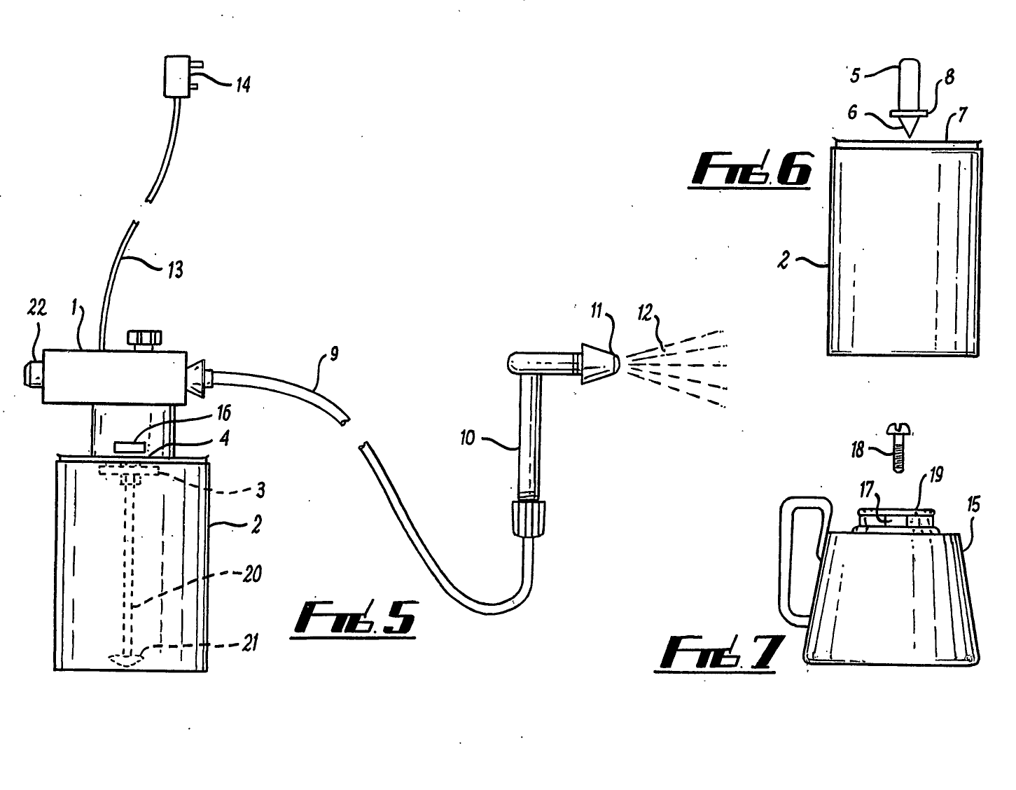

FIG. 5 is a schematic side view of a further spray device arrangement;

FIG. 6 is a schematic side view illustrating a piercing tool utilised with regard to a liquid container; and,

FIG. 7 illustrates a separate paint container vessel utilised with the arrangement depicted in FIG. 5.

There are at present spraying devices which are hand held and attached by a tube to a separate canister. There are also spray guns with canisters attached. These devices can be expensive.

It would be advantageous to provide a method whereby the operator of such products can have a cheap alternative and the versatility provided by a device which is also easy to clean, and may also have throw-away parts as an alternative to cleaning should the operator decide to discard them.

The main driving force of the spray device is provided by an electrically operated vibrator which can use the mains electrical supply or a battery.

The section containing the vibrator can have a handle fitted to the main body of the gun or it may be fitted on the fluid canister. This allows it to be fitted to the top of a tin containing a suitably diluted liquid which will pass easily through a spray jet head, for example fence protective liquid. This reduces the necessity to keep frequently filling a separate container which is usually attached to such spray guns. It also reduces the need to have to clean containers after use.

To enable the vibrator mechanism to be fitted to the top of a tin containing paint, a hole has to be made in the lid; this is done by the use of a specially shaped spike which can be hammered or pushed into it. The bottom of the vibrator mechanism has a threaded section which is placed through the hole and a collar is then screwed onto this when the lid has been removed. A rubber washer is used between the threaded section and the collar to stop any leakage of paint and air. The section which is threaded has a piece shaped in the centre to allow a tube with filter on the bottom to be pushed into it. Several tubes varying in length with detachable filters can be provided to reach to the bottom of tins that vary in depth, or a flexible tube could be used.

An adapter to replace the jet spray assembly, which is fitted on the spray gun to allow a small bore tube to be fitted to it, and a handle equipped with a jet attached to the other end. The tube and handle can be made cheap enough to throw away after use, and even the section containing the piston and jet assembly can be made cheap enough to throwaway to alleviate the need for cleaning.

Should the need arise for a small quantity of paint to be used, this can still be used in a separate container which has a handle attached to it, on the main body of the spray gun. To operate the vibrator when it is connected to the mains or battery voltage supply, a switch is suitably positioned on the side of the body containing it if the handle is on the jar. The switch is situated so that it can be suitably operated because the separate container's handle lines up with it. This is possible because the section housing the vibrator mechanism has a section either side of it that protrudes and has holes through them. These line up with sections that protrude on the separate container; two screws are used to secure them together and a rubber seal is fitted between to stop any liquid which may be in the container from leaking out.

There are at present spraying devices which are hand held and attached by a tube to a separate canister. There are also spray guns with canisters attached. These devices can be expensive.

FIG. 1 illustrates a spray gun 25, with the separate stem section 23 screwed into it, and showing the three ‘O’ seal rings 26, 27, 28 in position. A handle 30, is attached to the main body of the spray gun 25 with a switch 31 fitted into it. A fluid or paint container 32 is screwed onto the bottom of a body, of the spray gun 25.

The spray gun 25 is connected to the main electrical supply by the cable 33, and plug head 34. It is then operated by pressing the switch 31, which operates a vibrator.

The spray device in the form of gun 25 operates by causing a vibrator assembly 100 to cause axial movement in the direction of arrowhead A of a piston assembly secured within the separable spray stem 23. Electrical power is provided to the vibration assembly 100 such that a contact finger 101 oscillates to drive the piston spray projection propulsion mechanism within the stem section 23. Vibration of the mechanism causes piston movement within the jet 102 such that there is pressurisation within the container 2 which stimulates fluid, typically paint, flow into the stem for further spray distribution. In these circumstances, the jet 102 within the stem section 23 includes feed ports 103, 104 which respectively extend radially from that jet 102. Feed port 104 is coupled to the interior of the container 32 in order to cause pressurisation of the fluid 105. This pressurisation causes upflow of fluid through a filter siphon 106 in order that paint is presented through the feed port 103 to the stem jet 102. This fluid is then further projected by the piston 106 through a nozzle 107 for spray distribution. Use of piston vibration for spray distribution is known and as described previously requires precision manufactured components in order to ensure that a piston and/or valve arrangement within the jet of the spray device achieved pressurisation of the container and also presentation of the fluid for spray distribution through a nozzle. It will be understood that such accuracy necessitates relatively high tolerance machining operations and use of mostly metal components which render previous arrangements unacceptable for disposal in view of their costs. It will also be understood that when changing spray fluid type or at the end of a work period, it is necessary to clean down any spray device.

The present invention provides a separable stem section 23 which is secured within a passage of the gun body 25. The stem section 23 is made from relatively cheap plastics materials and so may be readily disposed of itself or at least a piston or nozzle combination core thrown away whilst, due to its easy removal and separation the remainder of the stem can be cleaned.

The separable stem segment 23 is secured within a passage 110 through screw threads 123. Thus the stem section 23 is positioned along the same axial direction (arrowhead A) as that of the vibration mechanism 100 acting through the finger 101 upon the piston propulsion mechanism within the jet 102. In order to avoid the necessity for accurate machining, both of the screw thread 123 and positioning of the ports 103, 104 relative to communication apertures in the stem 23 seals 26, 27, 28 are provided with gutter channels 108, 109 between them. These seals 26, 27, 28 effectively isolate the gutter channels 108, 109 whereby the feed port 104 for air compression within the canister 32 is isolated from the feed port 103 through which fluid such as paint is presented to the jet 102 for propulsion through the nozzle 107. Normally, these seals 26, 27, 28 are O ring seal elements secured within grooves of the stem section 23 such that they engage the interior wall of the passage formed in the gun body 25 in order to ensure the desired isolation between the ports 103, 104. In such circumstances provided there is at least partial overlap between the feed ports 103, 104 and the gutter channels 108, 109, it will be understood that the necessary functions of pressurisation within the canister 32 and paint presentation to the jet 102 are achieved. Thus, there is no necessity to provide accurate machining to ensure communication between the jet 102 and feed ports 103, 104 as with previous spray devices. The necessity for reduced accuracy therefore allows cast or rudimentarily machined plastic material sections to be used for the stem 23 with the result that there is a radical reduction in manufacturing costs whereby the stem 23 may be considered disposable. Clearly, a disposable stem will not require cleaning before further use.

FIG. 2 shows the separate stem section 23, which contains the piston and spraying assembly. As indicated above all of the section 23 can be made cheaply enough to throw away if necessary. The assembly has screw threads 24, on the outside to allow it to be secured into a passage of a main body of the spray gun 25, shown in FIG. 1. The screw threads 24 engage screw threads 23 of the passage 110 from in the body 25 in FIG. 1. On the outside of the section 23, three O ring seals 26, 27, 28 are fitted. These seals 26, 27, 28 are there to keep the ports 103, 104 of the spray guns separated and isolated. On the end of the separate section 23, a jet nozzle assembly or combination 29, is screwed on. This assembly 29 can be replaced if required by an adaptor so that a tube 9 in FIG. 5 below can be attached.

As indicated above, a finger 101 vibrates in the axial direction indicated by arrowheads A in order that through an oscillating action controlled by a spring 111, a piston valve 109 acts to create the pressurisation through the port 104 and stimulates fluid flow in a cavity 112 fed through the port 103. A regulating plug 113 is provided in the jet 102 in order that only when pressurisation in the cavity 12 is sufficient to overcome a spring 1 14 bias for the plug 1 13 will fluid flow along the jet 102 and out of the nozzle 107. In short, pressurisation of the fluid within the cavity 1 12 displaces the plug 113 such that fluid bypasses that plug 1 13 into the jets 112 and thereafter out of the nozzle 107. The plug 113 also helps retain pressure within the canister 32.

In the above circumstances it will be appreciated that the part of the stem section 23 which is most wetted by the fluid is the jet 102 and nozzle 107. There is limited liquid in the cavity 112 and feed port 103. In such circumstances it is convenient for a nozzle hood 115 to be detachable through a screw thread 1 16 such that the nozzle 107, spring 114 and plug 113 may be removed as a combination for disposal whereby the other parts, that is to say the remainder of the stem 23 and nozzle hood 115 may be cleaned. Such cleaning may be through soaking or otherwise. In such circumstances the remainder of the stem 23 can be easily cleaned or disposed of if the cavity 112 retains fluid which is difficult to remove such as thick paints, etc. Clearly upon reassembly if the nozzle 107, spring 114 and plug 113 are disposed of then a new such combination will be inserted within the stem 23 for subsequent operations of the spray device.

FIGS. 3 and 4 illustrate stem section 23 in isolation respectively as a side view and side cross section. Thus, a screw thread 123 is provided to secure the stem 23 in the passage of a spray device housing. Nodule elements 116 of a collar part 117 help to allow manual rotation in order to provide securing through the screw threads 123. The stem 23 incorporates gutter channels 108, 109 as indicated previously to facilitate communication with feed ports 103, 104 (FIGS. 1 and 2). Sink apertures 118, 119 are provided within these gutter channels 108, 109. The apertures 118, 119 have an acceptable circumferential spacing whereby a communication pathway between the jet 102 of the stem 23 and the respective feed ports 103, 104 is provided to ensure pressurisation of the canister 32 (not shown) and presentation of fluid such as paint through the feed port 103 for spray distribution as described previously. Within the outer surface of the circumferential wall of the stem 23, grooves 120, 121, 122 are provided to accommodate isolation seals as described previously as O ring seals 26, 27, 28 with regard to FIGS. 1 and 2. In such circumstances within a stem passage 110 these seal elements (26, 27, 28) ensure isolation between the feed ports (103, 104), sink apertures 118, 119 and the gutter channels 108, 109 whilst also ensuring an acceptable axial communication overlap range for good communication between these features in order to reduce the necessity for assembly accuracy, etc.

Within the stem 23 as indicated previously a jet 102 is provided for communication with the nozzle 107 (FIGS. 2 and 3). It will be appreciated that this jet 102 extends along the major longitudinal axis of the stem 23 defined by X-X in FIGS. 3 and 4. This axis X-X is also the centre axis of the passage 110 within which the stem 23 is secured. Removal of the stem 23 as indicated is by longitudinal axial displacement out of an open end of that passage 110 (FIGS. 1 and 2). Similarly assembly is through location within that passage 110. Normally location is through a screw thread assembly but it will be appreciated a bayonet fitting or other appropriate securing mechanism could be used, such as a retaining radial grub screw.

As indicated above the nozzle combination of nozzle 107, spring 114 and plug 113 is generally secured within the jet 102. Retention of this nozzle combination is provided by a shoulder engagement between the plug 113 and a part 43 of the jet 102 at one end and by constriction by a nozzle hood 115 at the other (FIGS. 1 and 2). This nozzle (107, 114, 113) combination is readily disposable even if the stem 23 itself is repeatedly used. It will be appreciated that the nozzle 107 will normally incorporate grooves and possible perforations through which the spray dispersion is propelled as required. In such circumstances the particular nozzle utilised in terms of groove dimensions, sizing and grading can be changed as required for different paint or fluid types or desired spray distribution.

One desirable feature of the present invention is to provide a spray stem section 23 and/or nozzle combination (107, 113, 114) which is sufficiently cheaply manufactured and assembled that it is readily disposable. In such circumstances these components are generally made from a plastics material cast to the appropriate shape in a mould. Inaccuracies in fabrication can be accommodated by the broad acceptable axial band or communication gap provided by the gutter channels 108, 109 in the stem to the sink apertures 118, 119 with isolation provided through the seal elements 26, 27, 28. Alternatively a spray stem in accordance with the present invention may take a tapered or conical configuration narrowing from the nozzle end which is forced into slight compression within the passage by the screw thread or other means of securing the stem section in the passage. In such circumstances, the tapered association between the stem section and the passage will cause seal isolation between the respective feed ports and sink apertures in the gutter grooves of the stem section. A compressive taper configuration may therefore allow the use of a stem section which does not incorporate specific seal elements such as O ring seals for isolation between the feed parts.

Also in accordance with the present invention there is provided a spray device arrangement as depicted in FIGS. 5 to 7. Thus, as shown in FIG. 5 a spray propulsion section 1, contains a vibrator and a pump mechanism attached to a tin of paint 2, using a collar 3, which is threaded onto a section of the section 1, which has been passed through a hole in the lid 4, and is also threaded to accept it. A tube 20, attached to it, with a filter 21, on the end, and this passes down into the bottom of the liquid in the tin 2.

Thus paint removed from the tin 2 is forced by pressurisation within the tin 2 upwards through the tube 20 into the vibrator and pump mechanism within the section 1 and thence onward through a feed pipe 9 to a spray head nozzle 11 in order to present a spray distribute 12 as shown. In order to retain such pressurisation the lid 4 is secured by some form of retainer to prevent pressurised detachment from the tin 2. Typically a handle 10 is provided to allow appropriate manipulation of the spray distribution 2 for fluid or paint coverage, etc. The vibrator within the section 1 operates in accordance with known principles utilising electrical power provided through a cable 13 and plug 14 secured to a power supply (not shown). A switch 22 operates to switch on and off the vibrator and therefore stimulate spray distribution 12. Alternatively, a wireless control switch could be secured to the handle 10 so that operation of the section 1 may be remotely controlled.

With the arrangement depicted in FIG. 5 it will be appreciated that an operator is only encumbered with the handle 10 and nozzle 11 combination rather than the weight of the vibration and pump mechanism secured to the tin 2. Thus, the user is subject to less work fatigue when operating the arrangement.

FIG. 6 illustrates use of a tool in order to gain access to the tin of paint 2. The tool 5 has a spike on an end 6. This spike is either hammered or pressed into the lid 7, of the tin of paint 2, to create a hole for the threads on the shaped section 1, (FIG. 5), to fit there through and then be held in position by the collar 3. The hole allows air to the tin 2 as well as paint out so that the tin 2 is pressurised by air entering the tin 2 whereby paint is forced out. The tool 5 has a section 8 which protrudes around its circumference to prevent it being driven too deeply into the lid, 7.

Attached to one end of the shaped section 1, (FIG. 5), is a flexible tube 9, the other end of the tube (12) is fitted to the handle 10, which is hollow to allow the liquid to pass up into a nozzle jet 11, which is screwed onto its end. The liquid from the tin of paint 2, can then pass from the tin 2 when the vibrator has been connected to the electric supply, it will then provide the spray distribution 12, out of the nozzle 11.

As indicated normally the arrangement connects the vibrator to a mains electrical supply through the cable 13, with a suitable plug 14. The switch 22, FIG. 5 is used to switch the electrical supply on or off. Alternatively, battery power could be used.

FIG. 7 shows a separate container 15, for use when paint has to be thinned before use in accordance with the arrangement shown in FIG. 5. The shaped section 1, FIG. 5, has flanges 16, which protrude either side with holes through-them. When the separate section 1, is placed on the top of the separate container 15, these line up with flanges 17, which have holes in them and are threaded. Two screws 18, are used to secure them together, a rubber washer 19, stops any leakage.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-27. (canceled)

28. A spray device comprising projection means to generate a fluid spray projection through a passage, a spray stem axially aligned within the passage to allow removal through an end of the passage. The stem including isolation means such that, when aligned, respective feed ports in the passage are isolated from one another and thereby fluid for the fluid spray projection may pass through at least one such feed port into the spray stem for spray projection out of a nozzle of the stem.

29. A device as claimed in claim 28 wherein the isolation means comprises O ring seals about the stem.

30. A device as claimed in claim 29 wherein the O ring seals are secured within grooves formed in the stem.

31. A device as claimed in claim 28 wherein spacing between the isolation means defines an acceptable tolerance band width for association with respective feed ports of the device.

32. A device as claimed in claim 28 wherein the feed ports communicate with circumferential channels formed in the stem.

33. A device as claimed in claim 32 wherein these circumferential channels include sink apertures connected to a jet.

34. A device as claimed in claim 33 wherein the jet directly leads to the nozzle and incorporates at least part of the means to generate a fluid spray projection.

35. A device as claimed in claim 28 wherein the project means includes a piston.

36. A device as claimed in claim 35 wherein this piston is electrically vibrated in order to stimulate spray projection.

37. A device as claimed in claim 35 wherein the piston is axially removable from the spray stem either with the spray stem from the passage or independently.

38. A device as claimed in claim 28 wherein the spray stem and the passage are a close fit.

39. A device as claimed in claim 28 wherein the spray stem and passage have reciprocal tapered or conical shaping.

40. A device as claimed in claim 28 wherein the spray stem is secured to the passage at the end of the passage.

41. A device as claimed in claim 28 wherein the stem is secured to the passage through a screw thread engagement or bayonet fitting or using a retaining screw.

42. A device as claimed in claim 28 wherein the spray stem is made from a plastics material.

43. A spray arrangement in which a spray propulsion section is secured to a fluid container in order to generate through vibration action propulsion of a fluid spray through a tube conduit to a spray nozzle which may be held remotely from the spray propulsion section.

44. An arrangement as claimed in claim 43 wherein the spray propulsion section includes a vibrator and a pump mechanism to propel fluid through the tube conduit to the spray head nozzle.

45. An arrangement as claimed in claim 43 wherein an operating switch for the arrangement is located upon the spray propulsion section.

46. An arrangement as claimed in claim 43 wherein a wireless switch is attached to a handle of the nozzle in order to allow remote control of the spray propulsion section.

47. An arrangement as claimed in claim 43 wherein the spray head nozzle is readily detached from the tube conduit for cleaning or disposal.

48. A tool for providing access to a fluid container incorporating a spike at one end in order to create an aperture upon which a spray propulsion section of an arrangement as claimed in claim 43 can be secured.

49. A fluid container incorporating reciprocal flange elements to accept a spray propulsion section of an arrangement as claimed in claim 43 such that pressurization of that container is readily achieved for propulsion of fluid retained within the container.
